(19) United States
(12) Patent Application Publication
(10) Pub. No.: US 2026/0046744 A1
(43) Pub. Date: Feb. 12, 2026

(54) METHODS, ARCHITECTURES, APPARATUSES AND SYSTEMS FOR MAC ADDRESS HANDLING FOR MULTI-HOP DEVICE TO DEVICE RELAY

(71) Applicant: InterDigital Patent Holdings, Inc., Wilmington, DE (US)

(72) Inventors: Taimoor Abbas, Sainte-Julie (CA); Jung Je Son, Warrington, PA (US); Samir Ferdi, Kirkland (CA)

(21) Appl. No.: 18/798,539

(22) Filed: Aug. 8, 2024

(51) Int. Cl. H04W 40/24; H04W 76/14; H04W 88/04

(52) U.S. Cl. CPC H04W 40/248; H04W 76/14; H04W 88/04

(57) ABSTRACT

Systems and methods are provided for multi-hop device to device relay. For example, a first PC5 signaling message may be received from a first WTRU relay comprising a MAC address for a source WTRU and the first WTRU relay. A mapping table that comprises the MAC address for the source WTRU and the first WTRU relay may be created. A second PC5 signaling message may be received from a second WTRU relay or a target WTRU comprising a MAC address for the target WTRU, MAC address for the source WTRU and/or MAC address for the second WTRU relay. The mapping table may be updated with the MAC address for the target WTRU. A third PC5 signaling message may be transmitted to the first WTRU relay, comprising the MAC address of the target WTRU, MAC address of the source WTRU and the MAC address of the first WTRU relay.

### TECHNICAL FIELD

The present disclosure is generally directed to the fields of communications, software and encoding, including, for example, to methods, architectures, apparatuses, systems related to multi-hop device to device relay.

### BACKGROUND

According to some approaches, the establishment of a link between a source end user equipment (UE) and a target end UE are deficient in that they do not provide for flexibility and different routes between the source end UE and the target end UE. For example, certain approaches may not provide suitable flexibility for establishment of a link between a source end UE and a target end UE via relay UEs, thus hindering user experience and/or limiting data transfer.

### SUMMARY

A method performed by a device is provided. For example, the method may include receiving a first PC5 signaling message from a first wireless transmit/receive unit (WTRU) relay, the first PC5 signaling message comprising a media access control (MAC) address for a source WTRU and the first WTRU relay, and creating a mapping table that comprises the MAC address for the source WTRU and the first WTRU relay. The method may also include receiving a second PC5 signaling message from a second WTRU relay or a target WTRU, the second PC5 signaling message comprising a MAC address for a target WTRU, MAC address for a source WTRU and/or MAC address for a second WTRU relay and updating the mapping table with the MAC address for the target WTRU.

The method may also include transmitting a third PC5 signaling message to the first WTRU relay, the third PC5 signaling message comprising the MAC address of the target WTRU, MAC address of the source WTRU and the MAC address of the WTRU relay.

In certain representative embodiments, the first PC5 signaling message may be a direct security mode (DSM) complete message or a direct link modification request message. The second PC5 signaling message may be a direct communication accept (DCA) message or a direct link modification accept message. The third PC5 signaling message may be a direct communication accept (DCA) message or a direct link modification accept message.

In certain representative embodiments, the second PC5 signaling message may include a MAC address for the second WTRU relay. The method may include receiving a DCR signaling message from the source WTRU or the first WTRU relay which comprises user information which relates to the second WTRU relay. Creating the mapping table may comprise creating a new mapping table or updating an existing mapping table generated prior to receiving the first PC5 signaling message.

In certain representative embodiments, updating the mapping table may comprise adding, in the mapping table, user information which relates to the second WTRU relay. Updating the mapping table may comprises adding, in the mapping table, a MAC address of the second WTRU relay.

In certain representative embodiments, a wireless transmit/receive unit (WTRU) is provided. The WTRU may be configured to receive a first PC5 signaling message from a first WTRU relay, the first PC5 signaling message comprising a media access control (MAC) address for a source WTRU and the first WTRU relay, and create a mapping table that comprises the MAC address for the source WTRU and the first WTRU relay.

The WTRU may be configured to receive a second PC5 signaling message from a second WTRU relay or a target WTRU, the second PC5 signaling message comprising a MAC address for a target WTRU, MAC address for a source WTRU and/or MAC address for a second WTRU relay and update the mapping table with the MAC address for the target WTRU. The WTRU may be configured to transmit a third PC5 signaling message to the first WTRU relay, the third PC5 signaling message comprising the MAC address of the target WTRU, MAC address of the source WTRU and the MAC address of the first WTRU relay.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an exemplary signaling diagram which illustrates a PC5 unicast link establishment procedure;

FIG. 3 is an exemplary signaling diagram illustrating a process for a Relay using MAC addresses for E2E connection mapping according to one or more embodiments;

FIG. 4 is an exemplary signaling diagram illustrating a process for a Relay using User info of UEs for E2E connection mapping according to one or more embodiments;

FIG. 5 is an example of a mapping table for E2E connection mapping according to one or more embodiments;

FIG. 6 is an example of a mapping table for E2E connection mapping according to one or more embodiments; and

FIG. 7 is a flow diagram illustrating a method for E2E connection according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

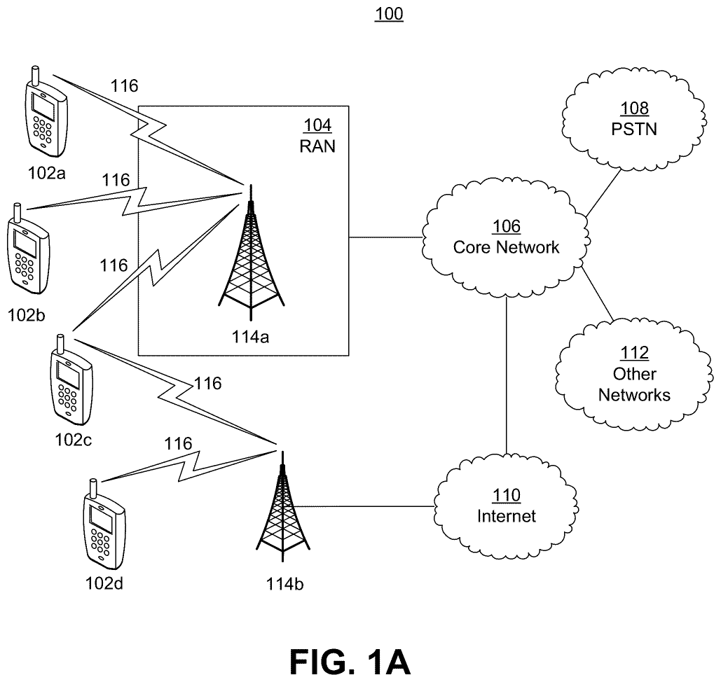

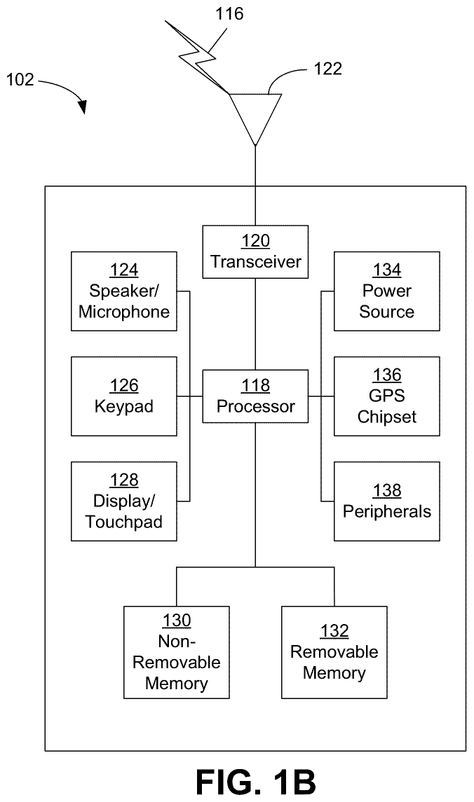

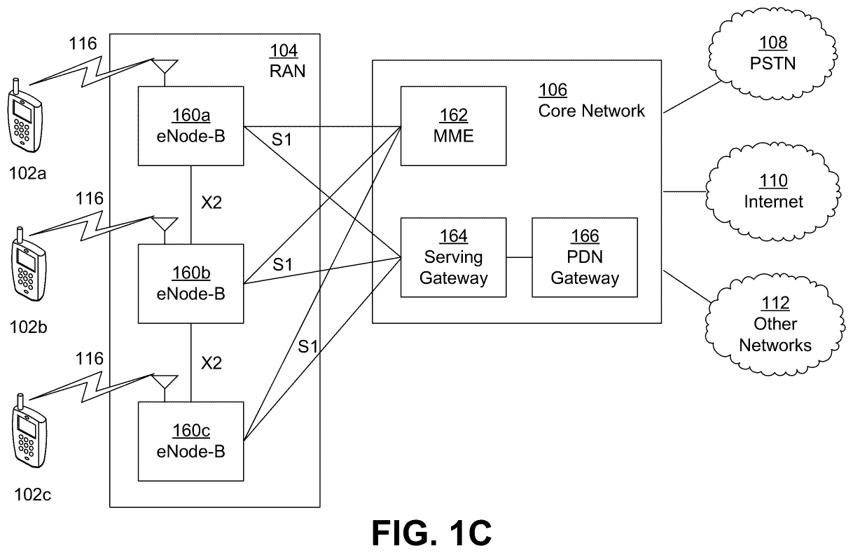

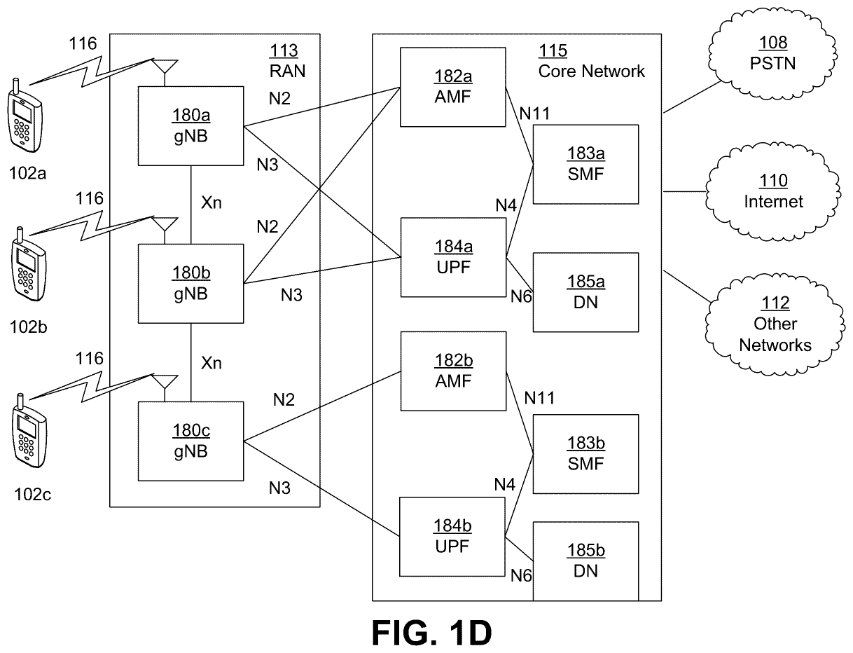

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain context s), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### PC5 Unicast Link Establishment

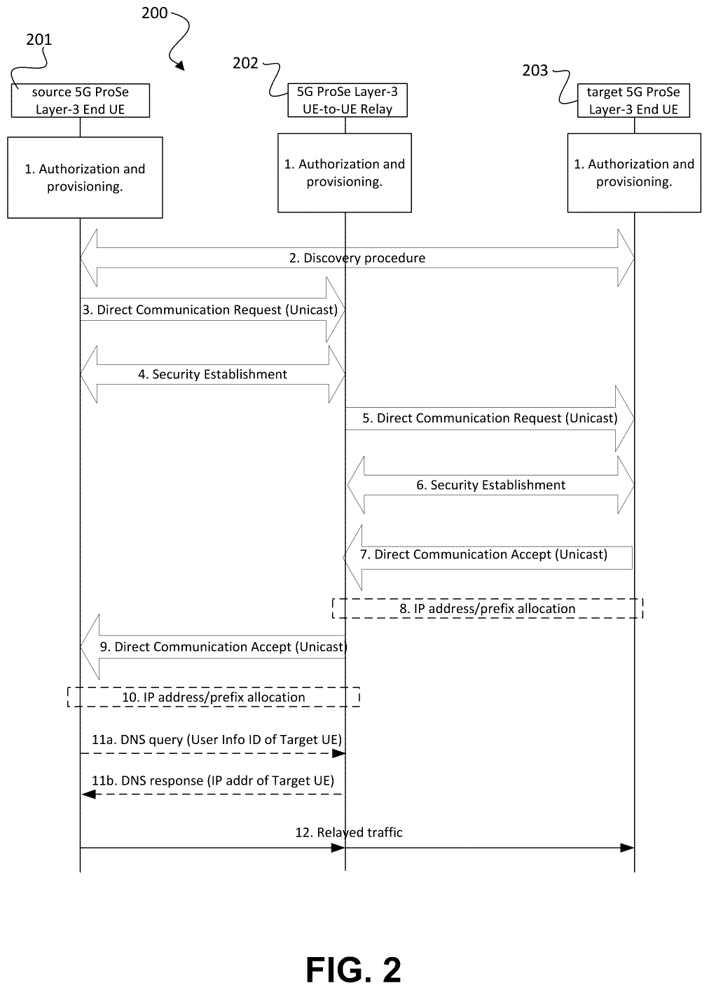

FIG. 2 is an exemplary signaling diagram 200 which illustrates a PC5 unicast link establishment procedure between a source end UE 201 and a target end UE 203 via a Layer-3 UE-to-UE Relay 202.

In the case that a PC5 link is used for transferring Ethernet traffic, the source end UE 201 sends its Ethernet MAC address to the UE-to-UE Relay 202 after security protection is enabled, which is illustrated at step 4 of FIG. 2, and may use a Direct Security Mode (‘DSM’) Complete message.

In the case that the Ethernet MAC address is already used by another target end UE 203, then the UE-to-UE relay 202 may send a message to the source end UE 201 which indicates that there is Ethernet MAC address conflict.

On completion of the Security Establishment procedure between the source end UE 201 and the UE-to-UE Relay 202 is completed, the UE-to-UE Relay 202 may send a Direct Communication Request (‘DCR’) message to initiate a unicast Layer-2 link establishment procedure.

The target end UE 203 may respond by establishing security with the UE-to-UE Relay 202.

The UE-to-UE Relay 202 may send the Ethernet MAC address of the source end UE 201 to the target end UE 203 once the security protection is enabled, which is illustrated at step 6 of FIG. 2, and may use a DSM Complete message.

The target end UE 203 may send a Direct Communication Accept (‘DCA’) message to the UE-to-UE Relay 202 with which it has successfully established security. As shown in step 7 of FIG. 2, the target end UE 203 may include its MAC address on a DCA message.

After receiving the DCA message from the target end UE 203, the UE-to-UE Relay 202 may send a DCA message to the source end UE 201 with which it has successfully established security. As shown in step 9 of FIG. 2, the UE-to-UE Relay 203 may include the target end UE 203 MAC address on a DCA message.

For Ethernet communication, the UE-to-UE Relay 202 may maintain the association between PC5 links and Ethernet MAC addresses received from the source and target end UEs 201, 203.

### U2U Relay Discovery and PC5 Setup

5G ProSe defines features and procedures which include 5G ProSe Direct Discovery, 5G ProSe Direct Communication, 5G ProSe UE-to-Network Relay, and 5G ProSe UE-to-UE Relay.

5G ProSe UE-to-UE Relay enables indirect communication between two end UEs. For UE-to-UE Relay, 5G ProSe UE-to-UE Relay Discovery and 5G ProSe Communication via UE-to-UE Relay are defined.

For 5G ProSe UE-to-UE Relay Discovery, both Model A and Model B discovery are supported. Model A uses a single discovery protocol message (Announcement), and Model B uses two discovery protocol messages (Solicitation and Response).

During 5G ProSe UE-to-UE Relay Discovery, information about two End UEs is shared between two End UEs to identify the discoverer End UE and discoveree End UE but those information of two End UEs are protected between two End UEs and are transparent to UE-to-UE Relays. Therefore a UE-to-UE Relay cannot acquire and identify information of End UEs and thus cannot utilize this information for routing discovery or other signaling message or for other purposes.

5G ProSe Communication via UE-to-UE Relay is possible with Layer2 UE-to-UE Relay or Layer3 UE-to-UE Relay. For Layer2 UE-to-UE Relay and Layer3 UE-to-UE Relay, 5G ProSe defines communication setup with discovery procedures. Additionally, it defines discovery integrated into a PC5 unicast link establishment procedure.

With Layer2 UE-to-UE Relay, an end-to-end PC5 link is established between the End UEs, via the Relay. PC5-S messages may then be exchanged between End UEs.

With Layer3 UE-to-UE Relay, each End UE establishes a PC5 link with the Relay and the Relay forwards messages towards End UEs. PC5-S messages are exchanged between End UEs and the Relay.

With Layer3 UE-to-UE Relay, when IP based data connection is used, after a PC5 link setup with a Relay, each End UE can be assigned an IP address by the Relay. This may be based on a DHCP mechanism or each End UE may assign its own IP address, which may be based on a link local IP address assignment mechanism and informed to the Relay. Whether to use DHCP or link local IP address assignment is determined during the security connection setup between an end UE and a UE-to-UE Relay.

### Multi-hop for U2N and U2U Relay

Multi-hop for U2N Relay features may enable a Remote UE to discover and communicate with a U2N Relay via one or more U2U relays. Multi-hop U2U Relay may enable End UEs to discover and communicate with each via more than one U2U Relay. Such multi-hop capability may be useful for communications for, e.g., first responders and in may enhance coverage, for example indoor coverage.

### Mobile Adhoc Network (MANET)

There is an available technology for supporting mobile ad hoc network which may be referred to as Mobile Adhoc Network (‘MANET’). Each router in a MANET may discover other routers by exchanging HELLO messages and each router may determine its 1-hop and 2-hop neighbors based on the exchanged HELLO messages. In such a case, each router may store the list of its 1-hop and 2-hop neighbors so that a MANET routing protocol may utilize the information.

MANET routing is based on an Optimized Link State Routing (‘OLSR’) Protocol. In this case, each router may exchange their topology information with other routers in the network on a regular basis. Each router may select two sets of Multipoint Relays (‘MPRs’), with each being a set of its neighbor routers that may cover all of its connected 2-hop neighbor routers. These two sets may be referred to as “flooding MPRs” and “routing MPRs” and may be used to achieve flooding reduction and topology reduction, respectively.

Flooding reduction may be achieved by control traffic being flooded through the network using hop-by-hop forwarding, but with a router only needing to forward control traffic that is first received directly from one of the routers that have selected it as a flooding MPR. Topology reduction may be achieved by assigning a special responsibility to routers selected as routing MPRs when declaring link state information. Routers which are not selected as routing MPRs need not send any link state information.

### Multihop UE-to-UE Relay with Mobile Adhoc Network (‘MANET’)

To support multi-hop ProSe UE-to-UE relays, each relay supporting multi-hop ProSe UE-to-UE relay functionality may form a collocated MANET router functionality that may connect with neighboring MANET routers and establish a mobile ad-hoc network. 5G ProSe communication may be used for communication between two UE-to-UE relays acting as MANET routers and all MANET messages exchanged between UE-to-UE relays may be considered as data traffic over a PC5 user plane interface.

### Overview

The establishment of a PC5 link between a Source End UE (‘S-End UE’) and a Target End UE (‘T-End UE’) may be via a Relay UE in a single hop configuration. In some examples, the S-End UE may sends its Ethernet MAC address to a UE-to-UE (‘U2U’) Relay, and the U2U relay may send the Ethernet MAC address of the S-End UE to the T-End UE once security protection is enabled. In an example, this security protection may be enabled using a Direct Security Mode (‘DSM’) Complete message. Similarly, the T-End UE may sends a Direct Communication Accept (‘DCA’) message to the U2U Relay, which has successfully established security with the T-End UE, and may include its MAC addr in such a DCA message.

Single-hop UE-to-UE Relay communication for Ethernet and via an Unstructured PDU session type may be supported under the PC5 protocol.

Herein, the term ‘Relay’, ‘U2U relay’, ‘UE-to-UE Relay 5G Prose Layer-3’, and ‘UE-to-UE Relay’ may be used interchangeably. Additionally, ‘end UE’ and ‘5G ProSe end UE’ may be used interchangeably, and an end UE may include both an ‘S-End UE’ and a ‘T-End UE’.

That which is described herein is on the basis that end UEs may exchange their MAC addresses via multi-hop U2U relays. The MAC address of the end UEs may be administered by the end UEs or by the Relay, that is to say that the end UEs may generate a new MAC address or may be allocated a new MAC address by the Relay as required, over the PC5 interface. Changing the MAC address of an end UE may reduce the likelihood of privacy issues.

That which is described herein assumes that all UEs involved in E2E link establishment are capable of multi-hop U2U relay communication. It is also assumed that the S-End UE and the T-End UE have discovered each other via a U2U Relay or via multiple U2U Relays, and the best route has been chosen during the discovery procedure.

### Relay Using MAC Addresses for E2E Connection Mapping

Exemplary steps for link establishment between an S-End UE and U2U Relay using MAC addresses follow. In a first step, a Relay may receive a DCR message from an S-End UE, for Ethernet traffic. In a second step, the Relay may send a DSM Command message to the S-End UE. In a third step, the Relay may receive a DSM Complete message, and this DSM Complete message may include the MAC address of the S-End UE and may include the MAC address of the T-End UE if these are available at the S-End UE via the previous direct communication.

In a fourth step, the Relay may create a mapping table that saves the MAC Address of the S-End UE and its own MAC Address. The Relay may be referred to as ‘U2U_R1’, and the mapping table may include the S-End MAC Address and the U2U_R1 MAC Address. This step of creating the mapping table may comprise updating a previously generated mapping table. This mapping table may have been generated as part of a Discovery and path selection for a multihop U2U relay procedure.

In some examples, for the mapping reference, the U2U relay may use the S-End UE MAC address and/or the T-End UE MAC address, or may use both.

The link establishment may include Direct Communication Accept (‘DCA’) messaging. In a fifth step, the Relay may receive a DCA message from another relay which includes the T-End UE MAC address. This DCA message may also include the S-End UE MAC address. In a sixth step, the Relay may update the mapping table described above to associate the T-End UE MAC address with the S-End UE MAC address for the E2E link establishment. In a seventh step, the Relay may send a DCA message to the S-End UE which includes the T-End UE MAC address.

Exemplary steps for link establishment between two U2U Relays, which may be termed ‘U2U_R1’ (as above) and ‘U2U_R2’ follow. In a first step, a first Relay (e.g. U2U_R1) may receive a DCR message from a second Relay, which may be the other Relay (e.g. U2U_R2), for Ethernet traffic. In a second step, the first Relay may send a DSM Command message to the second Relay. In a third step, the first Relay may receive a DSM Complete message from the second Relay.

This DSM Complete message received at the first Relay may include the MAC Address of an S-End UE, the MAC address of the first UE (U2U_R1), and may also include the MAC address of a T-End UE. The MAC address of the T-End UE may be included in the case that it is available at the S-End UE via previous direct communication and/or if it was sent by the S-End UE in a DCR message which may have occurred as part of a first hop. In a fourth step, which may be optional, the second relay, e.g. U2U_R2 may, if it to be used for direct communication between the two relays at 3rd hop or more, receive the MAC addresses of all Relays involved in the previous hops as part of a DSM complete message.

In a fifth step, the second Relay (e.g. U2U_R2) in a similar way to that described above, may create a mapping table that saves the MAC address of the S-End UE, the MAC address of the first Relay (e.g. U2U_R1) and its own MAC address, i.e. the MAC address of the second Relay (e.g. U2U_R2). This step of creating the mapping table may comprise updating a previously generated mapping table. This mapping table may have been generated as part of a Discovery and path selection for a multihop U2U relay procedure. For the mapping reference, the U2U relay may use the MAC address of S-End UE, and/or the MAC address of the T-End UE, or both.

The link establishment may include Direct Communication Accept (‘DCA’) messaging. In a fifth step, the Relay may receive a DCA message from another relay which includes the T-End UE MAC address. This DCA message may also include the S-End UE MAC address. In a sixth step, the Relay may update the mapping table described above to associate the T-End UE MAC address with the S-End UE MAC address for the E2E link establishment. In a seventh step, the Relay may send a DCA message to the S-End UE which includes the T-End UE MAC address.

In a sixth step, the second Relay may receive a DCA message from the T-End UE which may include the MAC address of the T-End UE and may also include the MAC address of the S-End UE. In a seventh step, the Relay may update the mapping table described above to associate the T-End UE MAC address with the S-End UE MAC address for the E2E link establishment. In an eight step, the second Relay may send a DCA message to another Relay, and the message may include the MAC address of the T-End UE and may also include the MAC address of the S-End UE.

Exemplary steps for link establishment between two a U2U Relay and T-End UE follow. In a first step, the Relay may send a DCR message to a T-End UE, for Ethernet traffic. In a second step, the Relay may receive a DSM command message from the T-End UE. In a third step, the Relay may send a DSM complete message to the T-End UE. This DSM complete message may include the MAC address of an S-End UE MAC addr, the MAC address of another Relay which may be a third Relay (‘U2U_R3’). In some cases, the DSM complete message may include the MAC addresses of all U2U relays involved.

The link establishment may include Direct Communication Accept (‘DCA’) messaging. In a fourth step, the Relay may receive a DCA message from the T-End UE which may include the MAC address of the T-End UE and may also include the MAC address of the S-End UE.

More generally, E2E route information may be available at the S-End UE and if it is available, it may be used by the S-End UE to initiate connection establishment and send a direct communication request (DCR) to the first U2U relay. In such a DCR message, the S-End UE may include the complete route information, which may include information about all of U2U relays to be used as part of a route.

As part of the process of relaying using MAC addresses for E2E connection mapping, a U2U Relay or U2U relays may share their MAC address. Additionally, communication between U2U Relays may use the MAC addresses of U2U Relays involved in the E2E multi-hop link. In such a case there may be header information which may include the MAC address of an S-End UE and the T-End UE. The U2U relays involved may manage the mapping table including user Info of the End UEs and user Info of U2U Relays along with MAC addresses for each of them.

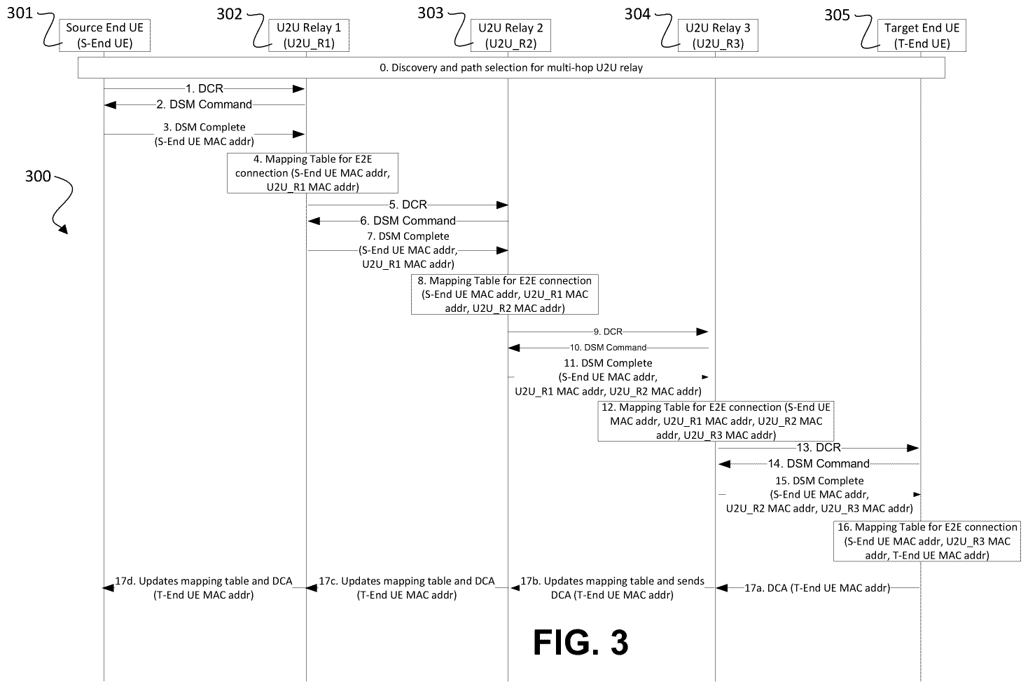

FIG. 3 is an exemplary signaling diagram illustrating a process 300 for a Relay using MAC addresses for E2E connection mapping. FIG. 3 includes a Source End UE (‘S-End UE’) 301, a Target End UE (‘T-End UE’) 305, and three Relay UEs, U2U Relay 1 (‘U2U_R1’) 301, U2U Relay 2 (‘U2U_R2’) 302, and U2U Relay 3 (‘U2U_R3’) 304. The steps shown in FIG. 3 will now be discussed.

In step 0 of FIG. 3, each of the UEs 301, 302, 303, 304, and 305 may have successfully registered, received confirmation and provisioning from the network. Additionally, the S-End UE 301 and the T-End UE 305 may have discovered each other via multiple U2U-Relays which may be U2U Relay 1 302, U2U Relay 2 303, and/or U2U Relay 3 304, using PC5 signaling, and the best route may have been chosen during the discovery procedure. U2U Relay 1 302 may be termed a first Relay 302, U2U Relay 2 303 may be termed a second Relay 303, and U2U Relay 3 304 may be termed a third Relay 304. The L2-IDs of the UEs 301, 302, 303, 304, 305 involved in the multi-hop U2U relay may be known by the UEs 301, 302, 303, 304, 305.

In step 1 of FIG. 3, U2U Relay 1 302 may receive a first message from the S-End UE 301. This first message may be a DCR message from the S-End UE 301, and may be for Ethernet traffic.

At step 2 of FIG. 3, U2U Relay 1 302 may send a DSM Command message to the Source End UE 301. At step 3, U2U Relay 1 302 may receive a DSM Complete message from the Source End UE 301. This DSM complete message may include the MAC address of the Source End UE 301. The DSM complete message may also include the MAC address of the Target End UE 305 if it available at the Source End UE 301 via previous direct communication.

At step 4 of FIG. 3, U2U Relay 1 302 may create a mapping table which includes the MAC address of the Source End UE 301 and its own MAC address, which in this case may be the MAC address of U2U Relay 1 302. Additionally, for the reference in the mapping table, U2U Relay 1 302 may use the MAC address of the Source End UE 301 and/or the MAC address of the Target End UE 305 if they are available, and/or may include both. This step of creating the mapping table may comprise updating a previously generated mapping table. This mapping table may have been generated as part of a Discovery and path selection for a multihop U2U relay procedure.

At step 5 of FIG. 3, the first Relay, U2U Relay 1 302, may for example send a DCR message to a second Relay, U2U Relay 2 303. Moving to the perspective of U2U Relay 2 303, U2U Relay 2 303 may receive a DCR message from the first Relay, for example U2U Relay 1 302, for Ethernet traffic. A similar scenario may be reflected at step 9 of FIG. 3. U2U Relay 3 304 may receive a DCR message from the second relay, for example U2U Relay 2 303, for Ethernet traffic.

At step 6 of FIG. 3, the second Relay, U2U Relay 2 303 may for example send a DSM Command message to the first Relay, U2U Relay 1 302. A similar scenario may be reflected at step 10 of FIG. 3. The third Relay, U2U Relay 3 304, may send a DSM Command message to the second Relay, U2U Relay 2 303.

At step 7 of FIG. 3, the second Relay, U2U Relay 2, 303, for example, may receive a DSM Complete message from the first Relay, U2U Relay 1 302. The DSM Complete message may include the MAC address of the Source End UE 301. Additionally, the DSM Complete message may include the MAC address of the first Relay, U2U Relay 1 302. The DSM Complete message may also include the MAC address of the Target End UE 305 if it is available at the S-End UE via previous direct communication and if it was sent by the S-End UE in a DCR message in, for example, step 1. A similar scenario may be reflected at step 11 of FIG. 3. The third Relay, U2U Relay 3 304, may receive a DSM complete message from the second Relay, U2U Relay 2 303. This DSM Complete message may include the MAC address of the Source End UE 301. Additionally, the DSM Complete message may include the MAC address of the first Relay, U2U Relay 1 302 and the MAC address of the second Relay, U2U Relay 2 303. The DSM Complete message may also include the MAC address of the Target End UE 305 if it is available at the S-End UE via previous direct communication and if it was sent by the S-End UE in a DCR message in, for example, step 1.

The second Relay, U2U Relay 2 303, and/or the third Relay, U2U Relay 3 304 may receive as part of a DSM complete message, if it is for direct communication between the two relays at 3rd hop or more, the MAC addresses of all Relays involved in the previous hops. In an example, this may be the MAC addresses of U2U Relay 1 302 and U2U Relay 2 303.

At step 8 of FIG. 3, the second Relay, U2U Relay 2 303, may create a mapping table which includes the MAC address of the Source End UE 301 and the MAC address of each Relay used involved, which for example may include the MAC addresses of U2U Relay 2 303 and U2U Relay 1 302. Additionally, for the reference in the mapping table, U2U Relay 2 303 may use the MAC address of the Source End UE 301 and/or the MAC address of the Target End UE 305 if they are available, and/or may include both. This step of creating the mapping table may comprise updating a previously generated mapping table. This mapping table may have been generated as part of a Discovery and path selection for a multihop U2U relay procedure.

A similar scenario may be reflected at step 12 of FIG. 3. The third Relay, U2U Relay 3 304, may create a mapping table which includes the MAC address of the Source End UE 301 and the MAC address of each Relay used involved, which for example may include the MAC addresses of U2U Relay 3 304, U2U Relay 2 303 and U2U Relay 1 302. Additionally, for the reference in the mapping table, U2U Relay 3 304 may use the MAC address of the Source End UE 301 and/or the MAC address of the Target End UE 305 if they are available, and/or may include both. This step of creating the mapping table may comprise updating a previously generated mapping table. This mapping table may have been generated as part of a Discovery and path selection for a multihop U2U relay procedure.

At step 13 of FIG. 3, the first Relay, U2U Relay 3 304, may for example send a DCR message to a Target End UE 305. Moving to the perspective of Target End UE 305, Target End UE 305 may receive a DCR message from the third Relay, for example U2U Relay 3 304, for Ethernet traffic.

At step 14 of FIG. 3, the Target End UE 305 may for example send a DSM Command message to the third Relay, U2U Relay 3 304. At step 15 of FIG. 3, Target End UE 305, for example, may receive a DSM Complete message from the third Relay, U2U Relay 3 304. The DSM Complete message may include the MAC address of the Source End UE 301. Additionally, the DSM Complete message may include the MAC address of the first Relay, U2U Relay 1 302, the MAC address of the second Relay, U2U Relay 2 303, and the MAC address of the third Relay, U2U Relay 3 304. The DSM Complete message may also include the MAC address of the Target End UE 305. In some cases, the DSM Complete message may include the MAC addresses of all of the Relays used.

At step 16 of FIG. 3, the T-End UE 305, may create a mapping table which includes the MAC address of the Source End UE 301 and the MAC address of each Relay used involved, which for example may include the MAC addresses of U2U Relay 3, 304, U2U Relay 2 303, and U2U Relay 1 302. Additionally, for the reference in the mapping table, U2U Relay 2 303 may use the MAC address of the Source End UE 301 and/or the MAC address of the Target End UE 305 if they are available, and/or may include both. This step of creating the mapping table may comprise updating a previously generated mapping table. This mapping table may have been generated as part of a Discovery and path selection for a multihop U2U relay procedure.

Step 17 of FIG. 3 may be divided into sub-steps, which as shown in FIG. 3, may include steps 17a, 17b, 17c, and 17d. These steps may be related to Direct Communication Accept (‘DCA’) messages, which may be sent in response to the DCR messages discussed in steps 1, 5, 9, and 13. The DCA messages may carry the MAC address of the Target End UE 305.

At step 17a of FIG. 3, Target End UE 305 may send a DCA message to the third Relay, U2U Relay 3 304 which may include the MAC address of the Target End UE 305 and may also include the MAC address of the Source End UE 301.

At step 17b of FIG. 3, upon reception of the DCA message from the Target End UE 305, the third Relay, U2U Relay 3 304, may updates the mapping table to associate the MAC address of the Target End UE 305 with the MAC address of the Source End UE 304 for the E2E link establishment. The third Relay, U2U Relay 3 304, may then send a DCA message to the second Relay, U2U Relay 2 303, which may include the MAC address of the Target End UE 305 and MAC address of the U2U relay 3 204. This DCA message may also include the MAC address of the Source End UE 301.

At step 17c of FIG. 3, the second Relay, U2U Relay 2 303, may receive a DCA message from the third Relay, U2U Relay 3 304, which may include the MAC address of the Target End UE 305, MAC address of the U2U Relay 2 303 and may also include the MAC address of the Source End UE 301. The second Relay, U2U Relay 2 303 may also update the mapping table to associate the MAC address of the Target End UE 305 with the MAC address of the Source End UE 301 for the E2E link establishment.

At step 17d of FIG. 3 a scenario similar to step 17c may occur, such that the first Relay, U2U Relay 1 302, may receive a DCA message from the second Relay, U2U Relay 2 303, which may include the MAC address of the Target End UE 305, MAC address of the U2U Relay 1 302 and may also include the MAC address of the Source End UE 301. The first Relay, U2U Relay 1 302 may also update the mapping table to associate the MAC address of the Target End UE 305 with the MAC address of the Source End UE 301 for the E2E link establishment.

### Relay Using User Information of the End UEs for E2E Connection Mapping

Link establishment between an S-End UE and a U2U relay may also be carried out using User Information. Accordingly, exemplary steps for link establishment between an S-End UE and U2U Relay using User Information follow. User Information of UEs may be used to construct a mapping table such that messages may be forwarded between an S-End UE a T-End UE using multi-hop U2U relay communication. In some cases, and/or in some alternatives, IP addresses of the UEs may be used instead of, or in addition to, the user info.

In a first step, similar to that described in connection with the steps for S-End UE and U2U Relay using MAC addresses, a Relay may receive a DCR message from an S-End UE, for Ethernet traffic. The DCR message may include User info about the S-End U, a first Relay, and the T-End UE, which may be termed ‘S-End UE’, ‘U2U_R1’, and ‘T-End UE’ respectively. The DCR message may optionally also include the User info for a second Relay and a third Relay, which may be termed ‘U2U_R2’ and ‘U2U_R3’ respectively, if the complete route info is available at the S-End UE and is to be shared with the intermediate U2U Relays. In a second step, the Relay may send a DSM Command message to the S-End UE. In a third step, the Relay may receive a DSM Complete message, and this DSM Complete message may include the MAC address of the S-End UE.

In a fourth step, the Relay may create a mapping table that saves the User info of the each of the UEs as received in the DCR message from the S-End UE. For example, this User info may include the User info of the S-End UE, the first Relay, the second Relay, the third Relay, and the T-End UE (‘S-End UE’, ‘U2U_R1’, ‘U2U-R2’, ‘U2U-R3’, and ‘T-End UE’) along with the MAC address of the S-End UE received in the DSM complete message. This step of creating the mapping table may comprise updating a previously generated mapping table. This mapping table may have been generated as part of a Discovery and path selection for a multihop U2U relay procedure.

The link establishment may include Direct Communication Accept (‘DCA’) messaging. In a fifth step, the Relay may receive a DCA message from another relay which includes the T-End UE MAC address. This DCA message may also include the S-End UE MAC address. In a sixth step, the Relay may update the mapping table to associate the T-End UE MAC addr. with the S-End UE User Info for the E2E link establishment. In a seventh step, the Relay may send a DCA message to the S-End UE which includes the T-End UE MAC address.

Exemplary steps for link establishment between two U2U Relays, which may be termed ‘U2U_R1’ (as above) and ‘U2U_R2’ follow. In a first step, a first Relay (e.g. U2U_R1) may receive a DCR message from the a second Relay, which may be the other Relay (e.g. U2U_R2), for Ethernet traffic. This DCR message may include User info for the S-End UE, the second relay, and the T-End UE (‘S-End UE’, ‘U2U_R2’, and ‘T-End UE’). Optionally, this message may also include the User info for the first and third Relays (‘U2U_R1’ and ‘U2U_R3’) if the complete route info was available at the S-End UE and it was shared by the S-End UE during a previous hop. In a second step, the first Relay may send a DSM Command message to the second Relay. In a third step, the first Relay may receive a DSM Complete message from the second Relay.

This DSM Complete message received at the first Relay may include the MAC Address of an S-End UE, the MAC address of the first UE (U2U_R1), and may also include the MAC address of a T-End UE.

In a fifth step, the second Relay (e.g. U2U_R2) in a similar way to that described above, may create a mapping table that saves the User information of the UEs received in the DCR message from the S-End UE. For example, this may include the User info of the S-End UE, the first Relay, the second Relay, the third Relay, and the T-End UE (‘S-End UE’, ‘U2U_R1’, ‘U2U_R2’, ‘U2U_R3’, and ‘T-End UE’. The mapping table may also be updated to include the MAC address of the U2U relay that is received in the DSM complete message from the other relay. This step of creating the mapping table may comprise updating a previously generated mapping table. This mapping table may have been generated as part of a Discovery and path selection for a multihop U2U relay procedure.

The link establishment may include Direct Communication Accept (‘DCA’) messaging. In a fifth step, the Relay may receive a DCA message from the T-End UE may include the T-End UE MAC address. This DCA message may also include the S-End UE MAC address. In a sixth step, the Relay may update the mapping table described above to associate the T-End UE MAC address with the S-End UE MAC address for the E2E link establishment. In a seventh step, the Relay may send a DCA message to the S-End UE which includes the T-End UE MAC address.

Exemplary steps for link establishment between two a U2U Relay and T-End UE follow. The U2U Relay may be the third Relay (‘U2U_R3’). In a first step, the Relay may send a DCR message to a T-End UE, for Ethernet traffic. The DCR message may include User info about all of the UEs involved in the E2E link. This may include the S-End UE, a first Relay, a second Relay and the T-End UE, which may be termed ‘S-End UE’, ‘U2U_R1’, ‘U2U_R2’, and ‘T-End UE’ respectively. In a second step, the Relay may receive a DSM command message from the T-End UE. In a third step, the Relay may send a DSM complete message to the T-End UE. 6 Relay sends a DSM complete message to the T-End UE. This DSM complete message may include the MAC address of an S-End UE and the MAC address of the third Relay (‘U2U_R3’).

The link establishment may include Direct Communication Accept (‘DCA’) messaging. In a fourth step, the Relay may receive a DCA message from the T-End UE which may include the MAC address of the T-End UE.

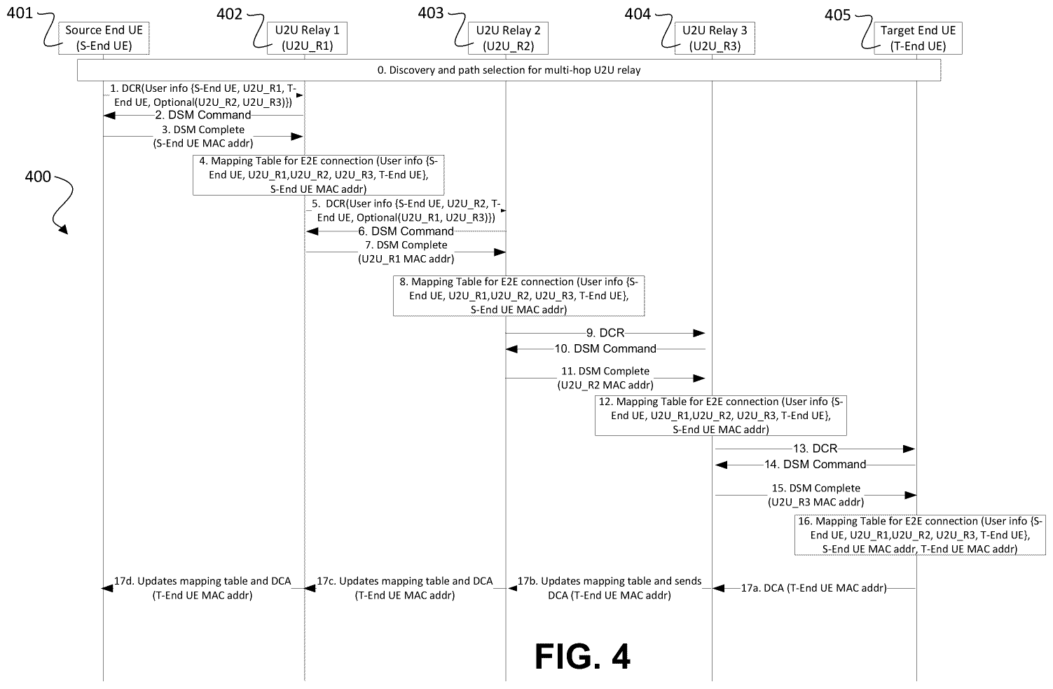

FIG. 4 is an exemplary signaling diagram illustrating a process 400 for a Relay using User info of UEs for E2E connection mapping. That which is described in connection with FIG. 4 may differ from that described in connection with FIG. 3, but may differ in that the U2U relays 402, 403, 404 may not use the MAC addresses for E2E link establishment. In this example, U2U Relays 402, 403, 404 may forward a packet from the Source and Target End UEs 401, 405 without encapsulating the MAC addresses of the U2U relays 402, 403, 404.

Therefore, for the example described below and in connection with FIG. 4, the mapping table at each UE 401, 402, 403, 404, 405 may be created and/or updated based on the user info ID of U2U relays 402, 403, 404 and the Source and Target End UEs 401, 405. In this example, the U2U relays 402, 403, 404 may manage a mapping table including User info of the Source and Target End UEs 401, 405 and user Info of U2U Relays 402, 403, 404. The mapping table may include the MAC addresses of the Source and Target End UEs 401, 405 only.

In an example, it may also be assumed that each UE (the Source and Target End UEs 401, 405 and the Relays 402, 403, 404, during the discovery procedure denoted step 0 in FIG. 4, may have already created a mapping table using the user info of the UEs 401, 402, 403, 404, 405, for example including application layer IDs, and/or IP addresses of the UEs 401, 402, 403, 404, 405. This mapping may then be used to determine where and to whom to forward messages for E2E messages transfer between the Source End UE 401 and the Target End UE 405. These mapping tables may then be updated to include the MAC addresses of the Source and Target End UEs 401, 405, for Ethernet traffic.

The following examples may use User info of the relevant UEs 401, 402, 403, 404, 405 to construct a mapping table such that messages may be forward between the Source End UE 4-1 and the Target End UE 405 using multi-hop U2U relay communication. In an alternative, IP addresses of the UEs 401, 402, 403, 404, 405 may be used instead of, or in addition to, the User info.

FIG. 4 includes a Source End UE (‘S-End UE’) 401, a Target End UE (‘T-End UE’) 405, and three Relay UEs, U2U Relay 1 (‘U2U_R1’) 401, U2U Relay 2 (‘U2U_R2’) 402, and U2U Relay 3 (‘U2U_R3’) 404. The steps shown in FIG. 4 will now be discussed.

In step 0 of FIG. 4, each of the UEs 401, 402, 403, 404, and 405 may have successfully registered, received confirmation and provisioning from the network. Additionally, the S-End UE 401 and the T-End UE 405 may have discovered each other via multiple U2U-Relays which may be U2U Relay 1 402, U2U Relay 2 403, and/or U2U Relay 3 404, using PC5 signaling, and the best route may have been chosen during the discovery procedure. U2U Relay 1 402 may be termed a first Relay 402, U2U Relay 2 403 may be termed a second Relay 303, and U2U Relay 3 404 may be termed a third Relay 404. The L2-IDs of the UEs 401, 402, 403, 404, 405 involved in the multi-hop U2U relay may be known by the UEs 401, 402, 403, 404, 405.

In step 1 of FIG. 4, U2U Relay 1 402 may receive a first message from the S-End UE 401. This first message may be a DCR message from the S-End UE 401, and may be for Ethernet traffic. This DCR message at step 1 may include User info for the S-End UE 401, the first Relay, U2U Relay 1 402, and the Target End UE, 405. This DCR message may also include User info for the second Relay, U2U Relay 2 403 and the third Relay, U2U Relay 3 404, if the complete route is available at the Source End UE 401 and is to be shared with the intermediate U2U Relays 402, 403, 404.

At step 2 of FIG. 4, U2U Relay 1 402 may send a DSM Command message to the Source End UE 401. At step 3, U2U Relay 1 402 may receive a DSM Complete message from the Source End UE 401. This DSM complete message may include the MAC address of the Source End UE 401. The DSM complete message may also include the MAC address of the Target End UE 405 if it is available at the Source End UE 401 via previous direct communication.

At step 4 of FIG. 4, U2U Relay 1 402 may create a mapping table which includes the MAC address of the Source End UE 401 User info for the Source End UE 401, the first Relay 402, second Relay 403, the third Relay 404, and the Target End UE 405. This step of creating the mapping table may comprise updating a previously generated mapping table. This mapping table may have been generated as part of a Discovery and path selection for a multihop U2U relay procedure.

At step 5 of FIG. 4, the first Relay, U2U Relay 1 402, may for example send a DCR message to a second Relay, U2U Relay 2 403. Moving to the perspective of U2U Relay 2 403, U2U Relay 2 403 may receive a DCR message from the first Relay, for example U2U Relay 1 402, for Ethernet traffic. The DCR message may include the User info for the Source End UE 401, the first Relay, U2U Relay 1 402, and the Target End UE 405. A similar scenario may be reflected at step 9 of FIG. 4. U2U Relay 3 404 may receive a DCR message from the second relay, for example U2U Relay 2 403, for Ethernet traffic.

At step 6 of FIG. 4, the second Relay, U2U Relay 2 403 may for example send a DSM Command message to the first Relay, U2U Relay 1 402. A similar scenario may be reflected at step 10 of FIG. 4. The third Relay, U2U Relay 3 404, may send a DSM Command message to the second Relay, U2U Relay 2 403.

At step 7 of FIG. 3, the second Relay, U2U Relay 2, 403, for example, may receive a DSM Complete message from the first Relay, U2U Relay 1 402. The DSM Complete message may include the MAC address of the Source End UE 401. Additionally, the DSM Complete message may include the MAC address of the first Relay, U2U Relay 1 402. The DSM Complete message may also include the MAC address of the Target End UE 405 if it is available at the S-End UE via previous direct communication and if it was sent by the S-End UE in a DCR message in, for example, step 1. A similar scenario may be reflected at step 11 of FIG. 4. The third Relay, U2U Relay 3 404, may receive a DSM complete message from the second Relay, U2U Relay 2 403. This DSM Complete message may include the MAC address of the Source End UE 401. Additionally, the DSM Complete message may include the MAC address of the first Relay, U2U Relay 1 402 and the MAC address of the second Relay, U2U Relay 2 403. The DSM Complete message may also include the MAC address of the Target End UE 405 if it is available at the S-End UE via previous direct communication and if it was sent by the S-End UE 401 in a DCR message in, for example, step 1.

At step 8 of FIG. 4, the second Relay, U2U Relay 2 403, may create a mapping table which includes the MAC address of the Source End UE 401 and User info for each Relay involved, which for example may include the User info of U2U Relay 2 403 and U2U Relay 1 402. Additionally, for the reference in the mapping table, U2U Relay 2 403 may use the MAC address of the Source End UE 401 and/or the MAC address of the Target End UE 405 if they are available, and/or may include both. This step of creating the mapping table may comprise updating a previously generated mapping table. This mapping table may have been generated as part of a Discovery and path selection for a multihop U2U relay procedure.

A similar scenario may be reflected at step 12 of FIG. 4. The third Relay, U2U Relay 3 404, may create a mapping table which includes the MAC address of the Source End UE 401 and the MAC address of each Relay involved, which for example may include the User info of U2U Relay 3 404, U2U Relay 2 403, and U2U Relay 1 402. Additionally, for the reference in the mapping table, U2U Relay 3 404 may use the MAC address of the Source End UE 401 and/or the MAC address of the Target End UE 405 if they are available, and/or may include both. This step of creating the mapping table may comprise updating a previously generated mapping table. This mapping table may have been generated as part of a Discovery and path selection for a multihop U2U relay procedure.

At step 13 of FIG. 4, the first Relay, U2U Relay 3 404, may for example send a DCR message to a Target End UE 305. This DCR message may include User info for all of the UEs involved. This may, for example may include the User info of the S-End UE 401, U2U Relay 3 404, U2U Relay 2 403, and U2U Relay 1 402. Moving to the perspective of Target End UE 305, Target End UE 305 may receive a DCR message from the third Relay, for example U2U Relay 3 404, for Ethernet traffic.

At step 14 of FIG. 4, the Target End UE 405 may for example send a DSM Command message to the third Relay, U2U Relay 3 404.

At step 15 of FIG. 4, Target End UE 405, for example, may receive a DSM Complete message from the third Relay, U2U Relay 3 404. The DSM Complete message may include the MAC address of the Source End UE 301. Additionally, the DSM Complete message may include the MAC address of the first Relay, U2U Relay 1 302, the MAC address of the second Relay, U2U Relay 2 303, and the MAC address of the third Relay, U2U Relay 3 304. The DSM Complete message may also include the MAC address of the Target End UE 305. In some cases, the DSM Complete message may include the User info of all of the Relays 402, 403, 404 used.

At step 16 of FIG. 4, the T-End UE 405 may create a mapping table which includes the MAC address of the Source End UE 301 and the MAC address of the Target End UE 405, along with User info for each Relay 402, 403, 404 involved, which for example may include User info for U2U Relay 3, 404, U2U Relay 2 403, and U2U Relay 1 402. This step of creating the mapping table may comprise updating a previously generated mapping table. This mapping table may have been generated as part of a Discovery and path selection for a multihop U2U relay procedure.

Step 17 of FIG. 4 may be divided into sub-steps, which as shown in FIG. 4, may include steps 17a, 17b, 17c, and 17d. These steps may be related to Direct Communication Accept (‘DCA’) messages, which may be sent in response to the DCR messages discussed in steps 1, 5, 9, and 13. The DCA messages may carry the MAC address of the Target End UE 405.

At step 17a of FIG. 4, Target End UE 405 may send a DCA message to the third Relay, U2U Relay 3 404 which may include the MAC address of the Target End UE 405 and may also include the MAC address of the Source End UE 401.

At step 17b of FIG. 4, upon reception of the DCA message from the Target End UE 405, the third Relay, U2U Relay 3 404, may update the mapping table to associate the MAC address of the Target End UE 405 with the MAC address of the Source End UE 404 for the E2E link establishment. The third Relay, U2U Relay 3 404, may then send a DCA message to the second Relay, U2U Relay 2 403, which may include the MAC address of the Target End UE 405. This DCA message may also include the MAC address of the Source End UE 401.

At step 17c of FIG. 4, the second Relay, U2U Relay 2 403, may receive a DCA message from the third Relay, U2U Relay 3 404, which may include the MAC address of the Target End UE 405 and may also include the MAC address of the Source End UE 401. The second Relay, U2U Relay 2 403 may also update the mapping table to associate the MAC address of the Target End UE 405 with the MAC address of the Source End UE 401 for the E2E link establishment.

At step 17d of FIG. 4 a scenario similar to step 17c may occur, such that the first Relay, U2U Relay 1 402, may receive a DCA message from the second Relay, U2U Relay 2 403, which may include the MAC address of the Target End UE 405 and may also include the MAC address of the Source End UE 401. The first Relay, U2U Relay 1 402 may also update the mapping table to associate the MAC address of the Target End UE 405 with the MAC address of the Source End UE 401 for the E2E link establishment.

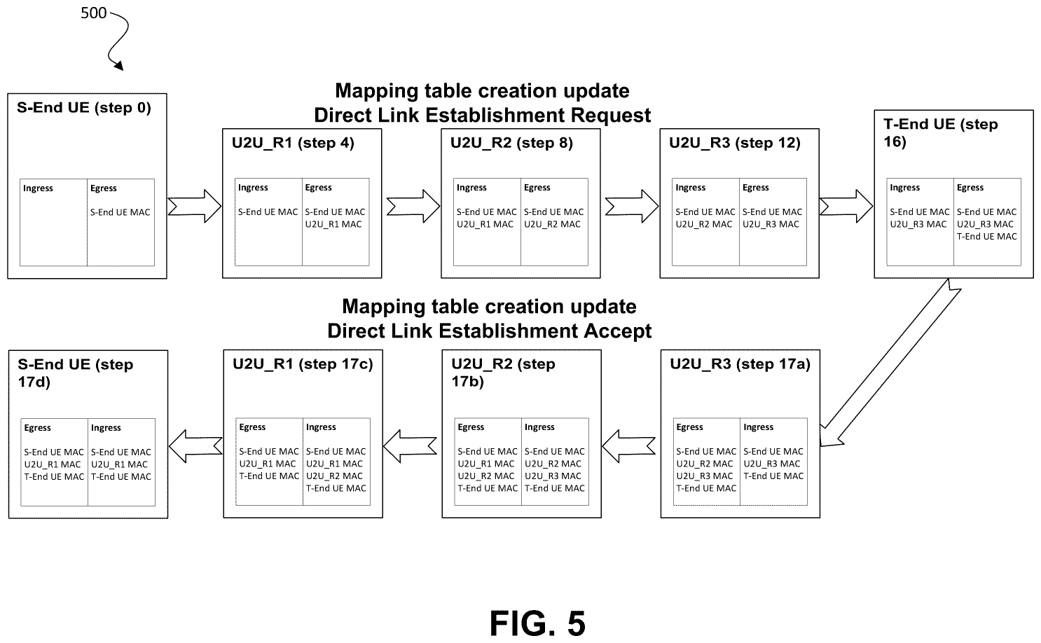

FIG. 5 is an example of a mapping table 500 which may be used in the signaling and processes described in connection with FIG. 3. An example of the mapping table is shown in FIG. 5 which may be created or updated during the direct link establishment procedure. Steps described herein may correspond to those described in FIG. 3.

The mapping table may be created and maintained at each of the UEs which may be the UEs in FIG. 3 and/or FIG. 4, and may include the Source End UE, the Relay UEs (U2U Relay 1, U2U Relay 2, and/or U2U Relay 3) and may also include the Target End UE. Each mapping table may have two parts, e.g. 1) the Ingress, which may be the information received by the UE and 2) the Egress, which may be the information sent by the UE.

In the example shown in FIG. 5, when the direct link establishment procedure is initiated for Ethernet traffic it may include two parts, 1) a direct link establishment request and 2) a direct link establishment acceptance.

During the direct link establishment request phase, the MAC addresses may be sent using the Direct Security Mode (DSM) complete messages from one UE to another UE. For example, e.g. U2U relay 2 in step 8 may receive MAC address of the Source End UE and the MAC address of the first Relay, U2U Relay 1 from U2U relay 1. The second Relay, U2U Relay 2 may save this information to the mapping table and may then cascade its own MAC address to the list and may the MAC addresses of the Source End UE and U2U Relay 2 to the third Relay, U2U Relay 3.

During the direct link establishment accept phase the MAC addresses may be sent using the Direct Communication Accept (DCA) messages from one UE to another UE. For example in step 8, U2U relay 2 may receive the MAC address of the Target End UE, the Source End UE and the MAC address of U2U Relay 3 from the third Relay, U2U Relay 3. U2U Relay 2 may save this information to the mapping table and may then cascade its own MAC address to the list and may send the MAC address of the Target End UE, the Source End UE, and the MAC address of U2U Relay 2 to U2U Relay 1.

When the E2E link is established and the Source End UE has a data packet to be sent, for Ethernet traffic, to the Target End UE, the Source End UE may then use the combination of MAC addresses of the Source End UE and Target End UE as a reference to find which relay UE to which the data may be forwarded. In this example it may be to U2U Relay 1. The Source End UE may use the MAC address of U2U Relay 1 to forward the data packet for Ethernet traffic. Similarly, each UE may use the MAC addresses of the next U2U relay or the Target End UE, as saved in the mapping table to forward the data packet.

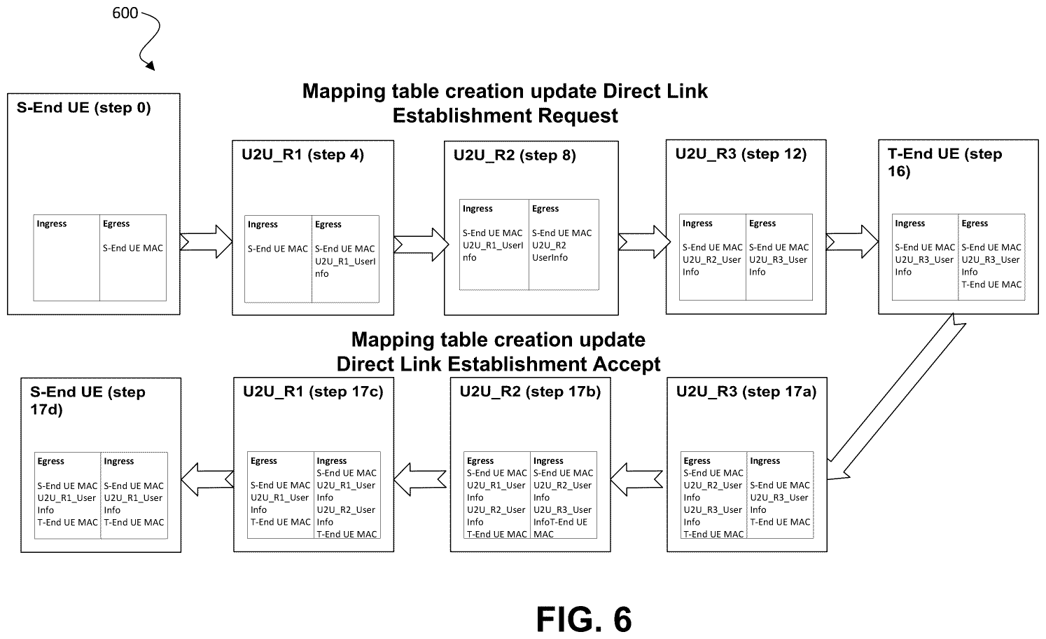

FIG. 6 is an example of a mapping table 600 which may be used in the signaling and processes described in connection with FIG. 4. An example of the mapping table is shown in FIG. 6 which may be created or updated during the direct link establishment procedure. Steps described herein may correspond to those described in FIG. 4.

That which is shown in FIG. 6 may be similar to that shown in FIG. 5, but the mapping table may include User info, or IP addresses, of the UEs as received in the Direct Communication Request (DCR) messages, which may differ from the MAC addresses described in connection with FIG. 5.

### MAC Address Handling for Direct Link Modification Procedure

In certain embodiments and examples, it may be assumed that a direct E2E link has already established between the Source End UE and the Target End UE. However, the direct link modification procedure may be performed to modify the existing direct link between any two UEs. For example, this may be because the E2E multi-hop path has been updated, a MAC address or MAC addresses of any of the UEs may be updated, an additional Source End UE or Target End UE may want to use the existing link direct link between the U2U relay or U2U relays, and/or to negotiate a new 5G ProSe UE-to-UE relay UE over the existing direct link. Therefore, in this example, the UE sending the direct link modification request message is termed the “initiating UE”and the other UE is called the “target UE”.

If the procedure is for direct link modification for ethernet traffic over multi-hop U2U relay, then the MAC addresses between any two UEs may be exchanged using the direct link modification request message and the direct link modification accept message. For the direct link modification procedure, the mapping tables update may be done in the same way as described above. The content, e.g. MAC addresses, of the direct link modification request message may be the same as the direct security mode complete message, and the content, e.g. MAC addresses, direct link modification request accept may be the same as the direct communication accept messages. The mapping of the MAC address in either of the above messages may follow the above, between the respective pair of UEs.

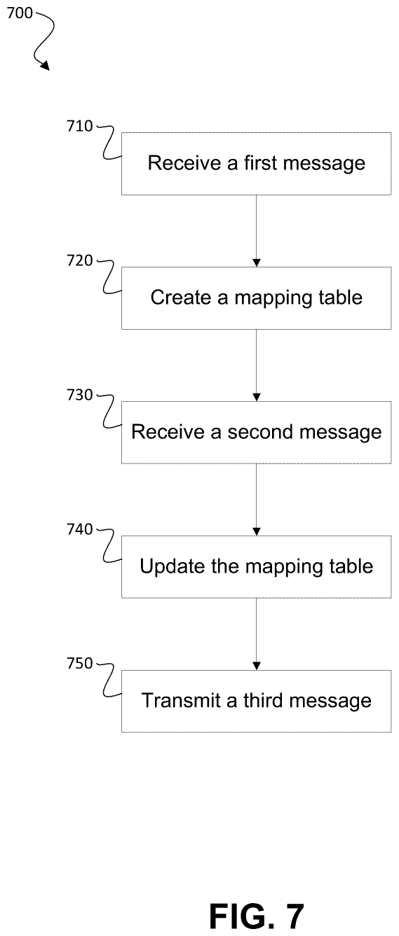

FIG. 7 is a flow diagram illustrating a method 700 for E2E connection according to one or more embodiments. The method 700 may, for example, be carried out by the WTRU 102 of FIG. 1B. The method 700 may, for example be carried out by a Relay UE 302, 303, 304, 402, 403, 404 as described herein. The method 700 may include step 710. At step 710, the WTRU may receive a first message. The first message may be a first PC5 signaling message which may comprise a media access control (‘MAC’) address for a source WTRU (which may be a Source End UE 301, 401 as described herein). The first PC5 signaling message may be a direct security mode (DSM) complete message or a direct link modification request message as described herein and may correspond to step 3, 7, 11, and/or 15 of FIG. 3 and/or FIG. 4.

The method 700 may include step 720. At step 720, the WTRU may create a mapping table as described herein. The mapping table may comprise the MAC address for the source WTRU and a first WTRU relay. The source WTRU may be a Source End WTRU 301, 401 as described herein, and the first WTRU relay may be U2U Relay 1 302, 402 as described herein. Creating the mapping table may comprise creating a new mapping table or updating a mapping table as described herein, and may correspond to steps 4, 8, 12, and/or 16 of FIG. 3 and/or FIG. 4 described herein. Creating the mapping table may comprise updating an existing mapping table generated prior to receiving the first PC5 signaling message.

The method 700 may include step 730. At step 730, the WTRU may receive a second message. The second message may be a second PC5 signaling message from a second WTRU relay which may be, for example, U2U Relay 2 303, 403, or a target WTRU, for example Target End UE 305, 405, and the PC5 signaling message may comprise a MAC address for a target WTRU which may be Target End UE 305, 405, MAC address for a source WTRU which may be Source End UE 301, 401 and/or MAC address for a second WTRU relay which may be U2U Relay 2 303, 403. The second PC5 signaling message may be a direct communication accept (DCA) message or a direct link modification accept message as described herein. This may correspond to steps 17a, 17b, 17c, and/or 17d of FIG. 3 and/or FIG. 4 as described herein.

The method 700 may include step 740. At step 740, the WTRU may update the mapping table as described herein. The mapping table may be updated with the MAC address for the target WTRU which may be Target End UE 305, 405. Updating the mapping table may comprise adding, in the mapping table, user information (which may be User info as described herein) which relates to the second WTRU relay which may be UE Relay 2 303, 403. Updating the mapping table may comprise adding, in the mapping table, a MAC address of the second WTRU relay which may be UE Relay 2 303, 403.

The method 700 may include step 750. At step 750, the WTRU may transmit a third message. This may comprise transmitting a third PC5 signaling message to the first WTRU relay which may be UE Relay 1 302, 404, and the third PC5 signaling message may comprise the MAC address of the target WTRU (which may be Target End UE 305, 405), and/or the MAC address of the source WTRU (which may be Source End UE 301, 401), and/or the MAC address of the WTRU relay (which may be the first WTRU relay, UE Relay 1 302, 402). The third PC5 signaling message may be a direct communication accept (DCA) message or a direct link modification accept message as described herein. This may correspond to steps 17a, 17b, 17c, and/or 17d of FIG. 3 and/or FIG. 4 as described herein.

In some representative embodiments, the method 700 may further include receiving a DCR signaling message from the source WTRU or the first WTRU relay which comprises user information which relates to the second WTRU relay as described herein. This may correspond to steps 1, 5, 9, and/or 13 of FIG. 3 and/or FIG. 4.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method performed by a wireless transmit/receive unit (WTRU) relay, comprising:
receiving a first PC5 signaling message from a first WTRU relay, the first PC5 signaling message comprising a media access control (MAC) address for a source WTRU and the first WTRU relay;
creating a mapping table that comprises the MAC address for the source WTRU and the first WTRU relay;
receiving a second PC5 signaling message from a second WTRU relay or a target WTRU, the second PC5 signaling message comprising a MAC address for a target WTRU, MAC address for a source WTRU and/or MAC address for the second WTRU relay;
updating the mapping table with the MAC address for the target WTRU; and
transmitting a third PC5 signaling message to the first WTRU relay, the third PC5 signaling message comprising the MAC address of the target WTRU, MAC address of the source WTRU and the MAC address of the WTRU relay.

2. The method of claim 1, wherein the first PC5 signaling message is a direct security mode (DSM) complete message or a direct link modification request message.

3. The method of claim 1, wherein the second PC5 signaling message is a direct communication accept (DCA) message or a direct link modification accept message.

4. The method of claim 1, wherein the third PC5 signaling message is a direct communication accept (DCA) message or a direct link modification accept message.

5. The method of claim 1, wherein the second PC5 signaling message includes a MAC address for the second WTRU relay.

6. The method of claim 1, further comprising receiving a DCR signaling message from the source WTRU or the first WTRU relay which comprises user information which relates to the second WTRU relay.

7. The method of claim 1, wherein creating the mapping table comprises creating a new mapping table.

8. The method of claim 1, wherein creating the mapping table comprises updating an existing mapping table generated prior to receiving the first PC5 signaling message.

9. The method of claim 1, wherein updating the mapping table comprises adding, in the mapping table, user information which relates to the second WTRU relay.

10. The method of claim 1, wherein updating the mapping table comprises adding, in the mapping table, a MAC address of the second WTRU relay.

11. A wireless transmit/receive unit (WTRU) comprising a processor configured to:
receive a first PC5 signaling message from a first WTRU relay, the first PC5 signaling message comprising a media access control (MAC) address for a source WTRU and the first WTRU relay;
create a mapping table that comprises the MAC address for the source WTRU and the first WTRU relay;
receive a second PC5 signaling message from a second WTRU relay or a target WTRU, the second PC5 signaling message comprising a MAC address for a target WTRU, MAC address for a source WTRU and/or MAC address for the second WTRU relay;
update the mapping table with the MAC address for the target WTRU; and
transmit a third PC5 signaling message to the first WTRU relay, the third PC5 signaling message comprising the MAC address of the target WTRU, MAC address of the source WTRU and the MAC address of the WTRU.

12. The WTRU of claim 11, wherein the first PC5 signaling message is a direct security mode (DSM) complete message or a direct link modification request message.

13. The WTRU of claim 11, wherein the second PC5 signaling message is a direct communication accept (DCA) message or a direct link modification accept message.

14. The WTRU of claim 11, wherein the third PC5 signaling message is a direct communication accept (DCA) message or a direct link modification accept message.

15. The WTRU of claim 11, wherein the second PC5 signaling message includes a MAC address for the second WTRU relay.

16. The WTRU of claim 11, wherein the processor of the WTRU is further configured to receive a DCR signaling message from the source WTRU or the first WTRU relay which comprises user information which relates to the second WTRU relay.

17. The WTRU of claim 11, wherein creating the mapping table comprises creating a new mapping table.

18. The WTRU of claim 11, wherein creating the mapping table comprises updating an existing mapping table generated prior to receiving the first PC5 signaling message.

19. The WTRU of claim 11, wherein updating the mapping table comprises adding, in the mapping table, user information which relates to the second WTRU relay.

20. The WTRU of claim 11, wherein updating the mapping table comprises adding, in the mapping table, a MAC address of the second WTRU relay.
